(19) United States
(12) Patent Application Publication
(10) Pub. No.: US 2014/0310036 A1
(43) Pub. Date: Oct. 16, 2014

(54) YIELD MANAGEMENT AND REPORTING

(71) Applicant: Scientific Revenue Inc., San Mateo, CA (US)

(72) Inventor: William Grosso, San Mateo, CA (US)

(73) Assignee: Scientific Revenue Inc., San Mateo, CA (US)

(21) Appl. No.: 14/252,497

(22) Filed: Apr. 14, 2014

Related U.S. Application Data
(60) Provisional application No. 61/812,659, filed on Apr. 16, 2013.

(51) Int. Cl. G06Q 10/06

(52) U.S. Cl. CPC G06Q 10/063
USPC 705/7.11

(57) ABSTRACT

A system for yield management comprising an application server that provides a web application where e-commerce managers may define cohorts and pricing policies, a web server that provides a web-based interface for interacting with the application server as well as a web-based interface where clients may query for pricing policies, a reporting server that computes aggregate statistics on cohorts, a cohorting server that computes cohort definitions, and an administration server that contextualizes cohort metrics for use in reporting operations.

### CROSS REFERENCE TO RELATED APPLICATIONS

This application claims priority to U.S. provisional patent application Ser. No. 61/812,659, titled “YIELD MANAGEMENT AND REPORTING”, which was filed on Apr. 16, 2013, the entire specification of which is incorporated herein by reference.

### BACKGROUND OF THE INVENTION

1. Field of the Invention

The present invention is in the field of product and service management, and more particularly in the field of yield management for online content products and services such as games and entertainment.

2. Discussion of the State of the Art

Yield maximization in the art is largely a large-scale business such as for airlines, cruises, hotels, etc. Games are fundamentally different, and predictive analysis is still crude particularly with respect to lifecycle analysis and churn prediction. Core ideas can be translated to the gaming industry, such as utilizing an increased role for A/B testing to compensate for a current lack of theoretical models or utilizing machine learning (which has progressed a lot in recent years). Utilizing existing “general purpose” infrastructure such as cloud-based technologies can reduce technological complexity.

Game companies are not exploring this, instead focusing on dealing with technological shifts (mobile gaming), platform shifts (frequent game console releases/updates), behavioral shifts (players tending away from or toward certain genres or gameplay elements), and basic product or sales management concerns. Analytics are often an afterthought at large game companies, or are out of reach of smaller studios or independent developers.

Service companies aren't solving these concerns, being instead focused on discovery and retention (which are themselves core concerns for game companies), whereas monetization companies focus on advertising.

What is needed is a solution that offers a unified system for reporting, analysis, and administration of yield management, and that should be scalable to accommodate a wide variety of potential use cases or infrastructures so as to facilitate solutions for a wide user base.

### SUMMARY OF THE INVENTION

Accordingly, the inventor has conceived and reduced to practice, in a preferred embodiment of the invention, a system and method or providing a unified, scalable, and user-friendly system and methods for reporting, analysis, and subsequent administration of yield management.

According to a preferred embodiment of the invention, a system for yield management comprising an application server that may provide a web application where e-commerce managers may define cohorts and pricing policies, a web server that may provide a web-based (such as may be accessible via a web browser on a computing device) interface for interacting with the application server as well as a web-based interface where clients may query for pricing policies (such as an online storefront or gaming paywall), a reporting server that may compute aggregate statistics on cohorts, a cohort definition server that computes cohort definitions, and an administration server that may contextualize cohort metrics for use in reporting operations, is disclosed. Central to all of these is the definition of a “cohort”. In order to make the system loosely coupled, and to make it as flexible as possible, the idea of a cohort may be defined in terms of a functional language—that is, we have a set of functions, which implicitly take a user as their argument. These are then compared to well-known values, and the results of those comparisons are combined with Boolean operators to give us a truth value (e.g. whether the user is in the cohort). This document describes various cohorting functions that may be present according to the invention, and how they may be combined. It does not define the precise syntax of the language, but for the avoidance of doubt, a lisp-like language would be more than sufficient. For example, (=(7_day_time_series (3_day_moving_average number_of_transactions_gold)) MONOTONE_UP) may represent an assertion that a given user's 3 day moving average on their number of transactions has been increasing for the past 7 days. Note that all moving averages are inherently anchored NOW and projected backwards, but the operation of creating a time-series anchors in preceding days.

According to the embodiment, an administration server may be utilized such as to contextualize or normalize metrics reported such as with per-capita, relative, or distribution measurements. Metrics often are recorded as raw numerical data such as “minutes played” being reported in a single active session. When contextualized, this metric data may become, for example, “minutes played per day”, or additionally contextualized for a particular cohort. Metrics reported might include a variety of relevant or desirable summary, demographic, revenue, spending, virtual currency, engagement, retention, gameplay, or churn metrics. Such metrics may be reported over time, facilitating use according to a variety of potential administrative actions such as those described above.

Further according to the embodiment, a reporting server may process cohort statistics and metrics to provide a user with meaningful reports that ideally should comprise at least the following:

Goal of Report

What should be immediately obvious on viewing

What can be figured out with a little bit of effort

What issues should be automatically highlighted

What actions the user can take to correct issues

What should be easy to navigate to from this report

What data is involved

From within a report, a user may use an administration tool to make changes and edit information, effecting a blended reporting and administration system. As envisioned, the system of the invention may be adaptable to mobile system architectures and implementations as well as larger, more traditional environments such as desktop computer workstations.

“Wallet-engagement” may be measured according to the invention. A person can play a free to play game indefinitely without spending; there are various useful measures of engagement: Are they playing? Are they acquiring skills? Are they bringing people on/acting social? Are they interacting with the economy? Ideally, the answers to the other these questions will be correlated; to the extent they're not, an imbalance in the game is thereby identified. If they're playing a lot and spending a lot, but not acquiring skills, they're a churn risk (frustration). If they're acquiring skills abnormally quickly, they're a churn risk (game is too easy). If they're playing a lot and acquiring skills, but not spending money, then we've got a long-term freeloader we need to convert. Such correlations and metrics may become apparent via the reporting and administration functions provided by the system of the invention, as described previously. Spend metrics may also be measured according to the invention, for example by measuring customer lifetime value, traditional payment-wall metrics non-engagement with the payment wall, the payment wall's impact on engagement, or take-rates on various aspects of the payment wall.

As previously described, the invention may utilize the notion of a “cohort”, referring to a user or group of users. “User” may refer to any individual or group using an electronic service or product. The invention may comprise a set of “canned cohorts”, or preprogrammed sample or dummy cohorts such as for testing or analysis purposes. Additionally, there may be a means for retiring or recycling cohorts, effectively updating any sample data or logic within a system. Such canned cohorts may be generated automatically, may be customizable for specific implementations or for particular users, and may have a set timeframe for data collection and reporting, and may have pricing rules or data associated with them as with a “real” cohort, i.e. a human customer.

Regarding cohorts, a user may have several basic operations. Such operations may include but are not limited to:
Examine cohort—this consists of selecting a cohort and viewing a wide range of metrics associated with it
Compare a cohort today with a past version of itself—given a cohort, a user may view data for now and an arbitrary past timeframe. Such a timeframe may be an absolute date (data from June 01), a relative date (data from previous three weeks), or other implementations such as configurable time-markers.
Compare multiple cohorts—similar to comparing against past version, but comparing current data for a plurality of different cohorts
Compare multiple cohorts across time—combining previous actions, view data for multiple cohorts across a timeframe
Restrict report—control who may view what data
Export data—the ability to export report data to other formats

According to a further embodiment of the invention, a client administration server may be used for managing various aspects of a client's program or service. According to the embodiment, the invention may provide such features as merchant services (such as order processing, pricing, or delivery), identity services (such as user or session tracking), game mechanics (such as A/B testing, rewards management, or fraud control), messaging (such as control of form and function of standardized messages such as “thank you” e-mails, or push-based messages or events such as alerts sent to offline users), or a “ledger” service for currency control (that may not be accessible to the public directly, and that may be used similarly for both real-world and virtual currencies). Currency support may comprise a fully-features, cloud-based “wallet”, or optionally the ability to give clients currency administration such as for creation of internal virtual currencies as may be desirable. Additionally, the invention may utilize repudiation handling and wallet updates, such as optionally utilizing push-based wallet updates to ensure synchronicity and validity between wallets if a dispute or discrepancy arises.

According to the embodiment, a client administration server may utilize open-source or other existing frameworks or elements such as for ease of integration with existing components that may already be in use (thereby lowering initial cost to a potential client, both in terms of monetary investment as well as infrastructure concerns). Administration may comprise such features as multi-tenancy and security models (user accounts, administrative access control), or the ability to view various read-only information such as user data (such as names, contact information, non-editable history, or other such information that may be identifiable with users), pricing rules (further described below), policy definitions, cohort definitions, and optionally the ability to synchronize data (such as for backup, version control, or synchronicity between multiple copies of similar data), such as is common in the art with cloud-based synchronization or data storage solutions.

With regard to pricing, an adaptive pricing library may be utilized. For example, a mobile device may operate a software library in communication with remote servers, such as to manage a payment wall for customers. Such a payment wall may present tailored offers or pricing based on previously reported user data, such as might optimize revenue and “cash-in” while reducing dissatisfaction or churn. Such an adaptive model may be scalable to other industries according to the invention, for example whenever a user makes a purchase of intellectual property (such as a software license or a copy of a movie), they may be charged the profit-maximizing price. Such an approach is appropriate for a variety of industries and media, such as television content or newspaper articles.

Adaptive pricing may be further scalable or adaptable, expanding to include virtual currencies. Game players and the game industry are shifting to a focus on immersive games with rich content catalogs. An appropriate adaptive pricing embodiment may comprise payment wall optimization, in-game point-of-sale (POS) optimization, web-based storefront optimization (such as for Amazon™ or other web-based vendor fronts), or mobile storefront optimization such as for tablet or smartphone app purchases.

It can be appreciated from the above that the invention may take the approach of “closing the loop” between reporting and report-based actions. This may utilize such approaches as detailed user models, user/cohort-specific pricing policies, or reports demonstrating outcomes and suggesting additional actions or improvements. An exemplary embodiment of the invention's operation is illustrated as a method of operation shown in FIG. 6, illustrating the closed-loop relationship between reporting and administration as envisioned by the inventors.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system architecture for yield management, according to a preferred embodiment of the invention.

FIG. 6 is a method diagram illustrating an exemplary method for yield management, according to a preferred embodiment of the invention.

FIG. 7 is a method flow diagram illustrating an exemplary method for cohort-based yield management according to a preferred embodiment of the invention.

### DETAILED DESCRIPTION

The inventor has conceived, and reduced to practice, a system and method or providing a unified, scalable, and user-friendly system and methods for reporting, analysis, and subsequent administration of yield management.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### DEFINITIONS

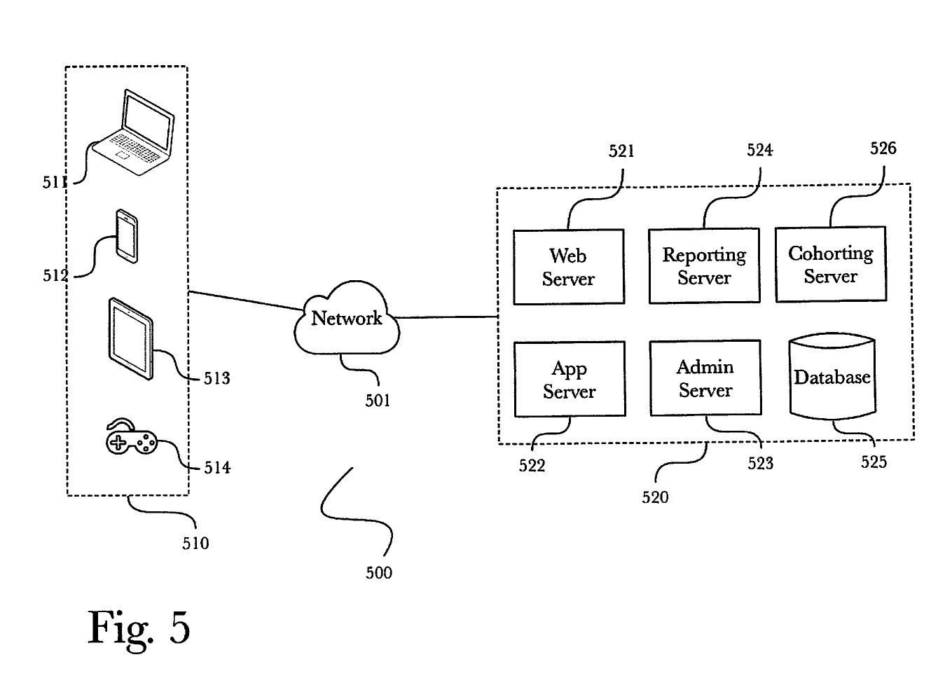

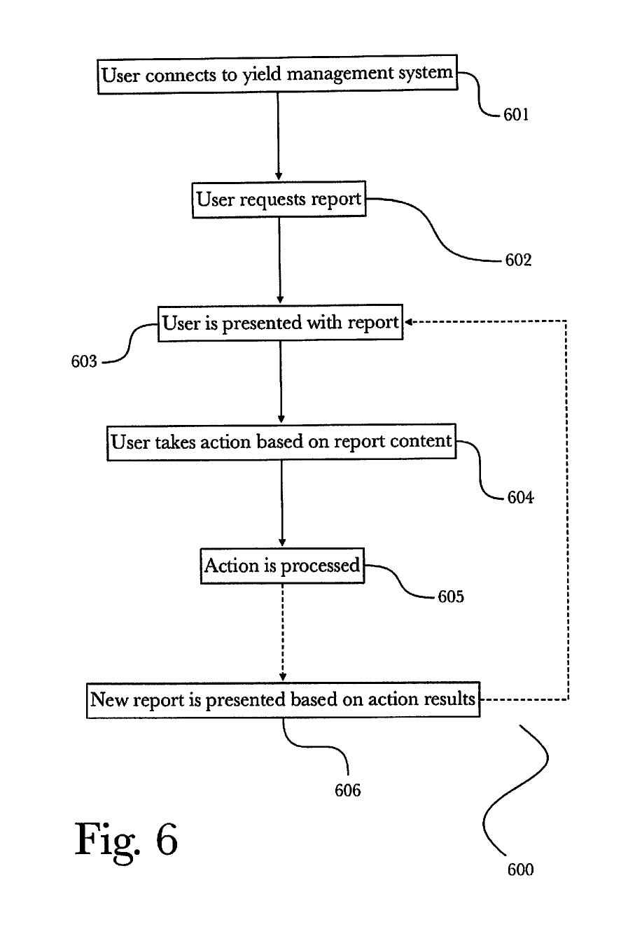

A “cohort”, as used herein, refers to a real or simulated human user or group of users, such as may interact with or operate electronic devices or services. Such cohorts may be the subject of yield management operations, several exemplary types of which are described below (referring to FIGS. 5-6).

A “canned” cohort, as used herein, refers to preprogrammed sample or dummy cohorts such as for testing or analysis purposes, such simulated cohorts ideally operating and behaving in a manner as closely simulating real human users as possible.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

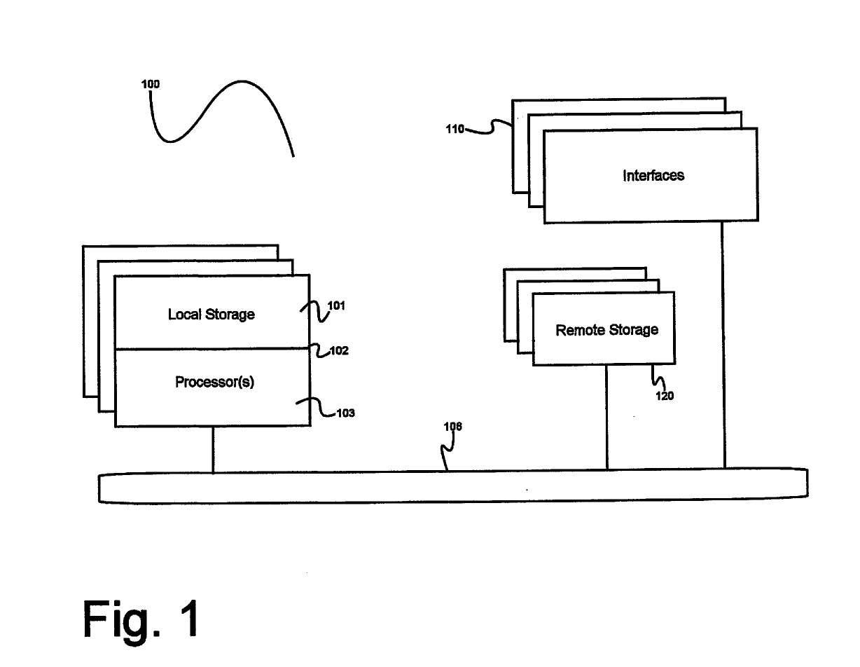

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

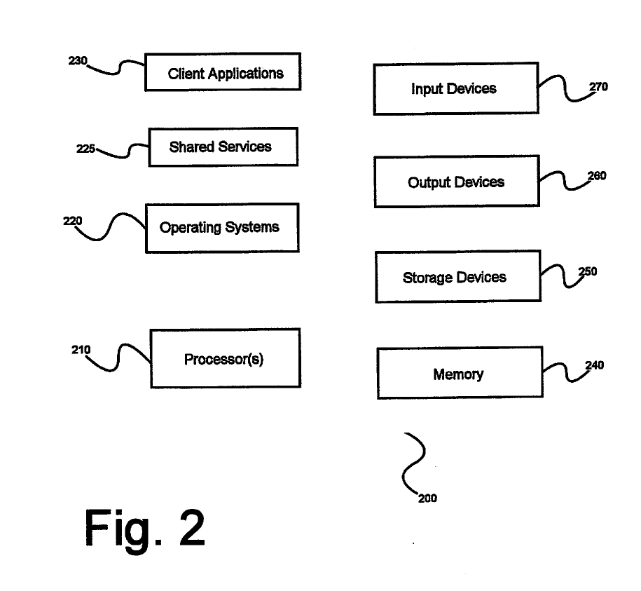

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

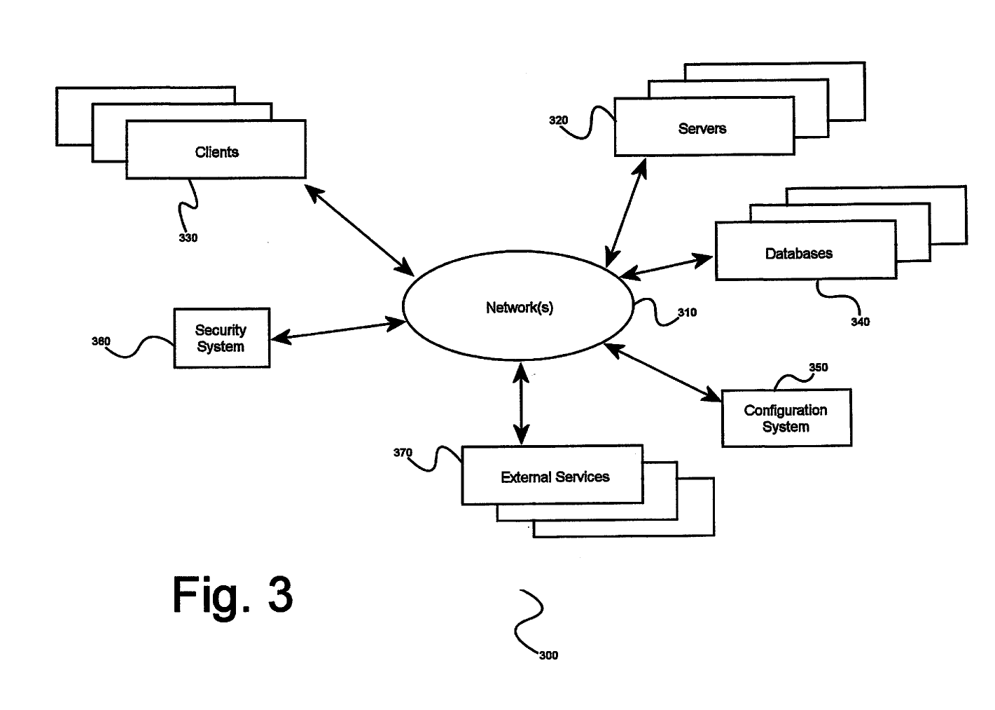

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

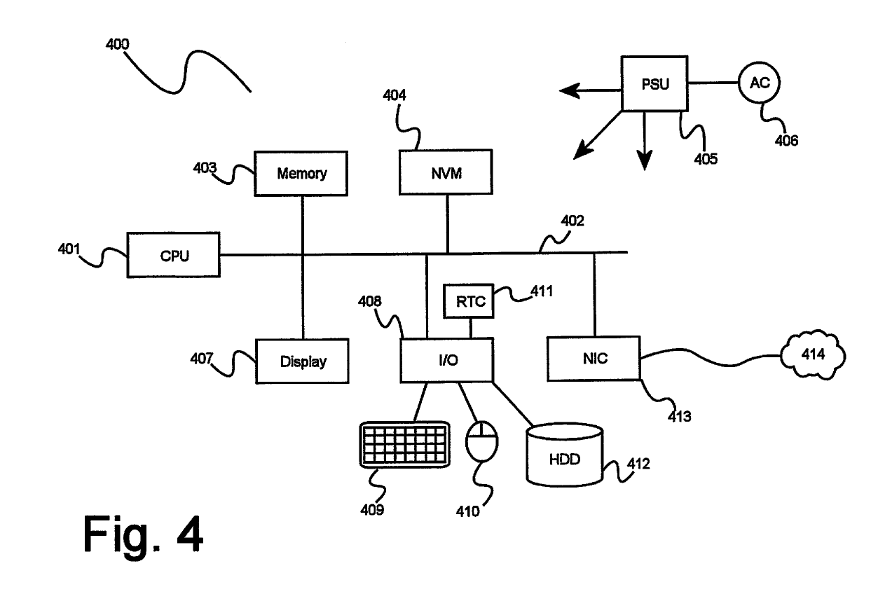

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

FIG. 5 is a block diagram illustrating an exemplary system architecture 500 for yield management, according to a preferred embodiment of the invention. As illustrated, various traditional components of a computing network may be interconnected and in communication via the Internet 501 or a similar data communications network. It should be appreciated by one having ordinary skill in the art, that such an arrangement is exemplary and a variety of connection and communication means exist which may be utilized according to the invention, and it should be further appreciated that various combinations of connections and communication means may be utilized simultaneously or interchangeably according to the invention.

As illustrated, a plurality of users 510 may interact with a yield management system 520 across a network 501 via a variety of hardware or software means common in the art, several examples of which are illustrated. It should be appreciated that such means as illustrated and described below are exemplary, and any of a variety of additional or alternate means may be utilized according to the invention. Hardware means may include (but are not limited to) electronic devices capable of communication over a network 501, such as a personal computer 511 (such as a laptop or desktop computer), mobile smartphone 512, a tablet computing device 513, or a video gaming console 514 (or other such dedicated gaming hardware, for example a handheld gaming device or an integrated home PC designed or utilized for gaming purposes, such as an OUYA™ or STEAM MACHINE™ device). As appropriate and according to the specific nature of a device being utilized, users 510 may interact using a variety of software means (not illustrated), such as a web browser accessing a webpage or other internet-enabled software (as may be appropriate when using a personal computer 511), or a mobile application (as may be appropriate when using a mobile smartphone 512 or tablet computing device 513). It should be appreciated that, as with physical devices described above, such means as described are exemplary and a variety of additional or alternate means may be utilized according to the invention. It should be further appreciated that such devices and means may communicate via multiple networks 501, either simultaneously (such as multi-band or MIMO configurations for wireless data communication) or interchangeably (such as a mobile smartphone with multiple radios for communication across a variety of protocols or frequencies).

As further illustrated, users 510 may communicate via a network 501 such as the Internet or other appropriate communication network, for such purposes as interaction with a yield management system 520, various components of which may be similarly connected to a network 501 for communication, and which may also be interconnected within system 520 for communication with other components. Such components may include (but are not limited to) a web server 521 that may operate web-accessible content such as webpages or interfaces for viewing by users and also may receive web interactions from users (such as an interactive administration interface for viewing reports or taking report-based actions, as described below), an application server 522 that may operate various software elements for interaction such as via web-enabled means operated by web server 521 (such as an interactive reporting application, as described below and such as might be interactive via an interface presented by a web server 521 as described above), a database 523 or similar data storage component that may store data from other components as well as provide such stored data for interaction (such as for viewing or modifying existing or historical reporting data, or storing cohort information such as definitions as described below), a reporting server 524 that may create or manage electronic reports, and an administration server 525 that may provide administration functions for user interaction (such as controlling or managing other components or features of system 520). It should be appreciated that internal components of a system 520 such as a reporting server 524 or administration server 525 may be directly accessible for user interaction (such as when a server operates its own interaction interface, as is common in the art with other computer applications) or indirectly via an interface or application operated by another component such as a web server 521 or app server 522, either simultaneously or interchangeably as appropriate according to the invention. For example, it is common in the art for a single software component such as an administration application stored and operating on a computing device such as an administration server 525 to be accessible via multiple means according to a user's preference or the nature of the desired interaction. For example, an integrated interface may be provided by an administration server 525 for basic interaction such as viewing the operational status of the server, while more complex interaction may be provided by a separate interface operated by a web server 521, allowing users a choice of interaction means.

As illustrated, a cohorting server 526 may be utilized for such purposes as to process, manage, and otherwise control cohort definitions. For example, user account management for a game-based arrangement might be handled by a cohorting server 526, such as to define attributes of user accounts (groups of which may be considered cohorts according to the invention), metrics by which cohorts are measured, scored, or reported, or any other such cohort-related functions. Additionally, cohorting server 526 may receive input from other components such as an administration server 525 for such purposes as to modify behavior or to alter specific cohorts, for example when a user wishes to alter the status of a user account or change the way in which certain metrics are tracked or reported. In this manner, a cohorting server 526 can be appreciated to serve multiple internal functions that are accessible to other components as needed.

As illustrated, reporting server 524 may be connected to and in communication with other components such as app server 522 such as to provide functionality for interaction via software elements (as may be appropriate for mobile device applications, wherein a user might directly view or interact with generated reports), web server 521 such as to provide functionality for interaction via webpages or similar web-enabled means, or database 523 such as to store and retrieve reports or information relevant to reporting (such as configuration or other criteria for generation of reports). In this manner it can be appreciated that a function of reporting server 524 may be to provide functionality to other components that may operate specific means of interaction, while still optionally providing functionality directly to user applications or devices 510 (as described above), thereby enabling a variety of arrangements and means of interaction according to the invention.

Reporting server 524 may perform reporting functions as described above, such as generating and providing reports of cohort definitions, behavior, or interactions, metrics-based reporting as described below, or other various reporting functions that may be appropriate according to a particular use case according to the invention. It should also be appreciated that the functions provided by reporting server 524 may operate independently of additional components, such as in an arrangement that simply produces reports for use in an external system not part of the invention. For example, a reporting service for yield management may produce reports and provide them to an external or third-party product or service for presentation to, consumption by, or interaction from a user, such as a software-as-a-service (SaaS) or cloud-based use case. It should therefore be appreciated that additional components such as database 523 or app server 522 may be utilized as needed in various configurations according to the invention, and the arrangement illustrated is exemplary and by no means the only possible arrangement and that alternate arrangements such as might incorporate more, fewer, or alternate components may be possible according to the invention.

As further illustrated, administration server 525 may be connected and in communication with other components in a manner similar to that described above for reporting server 524, such as being connected to app server 522 such as to provide functionality for direct interaction via software elements (such as, again, in a mobile device application wherein a user might perform functions directly via an application interface), web server 521 such as to provide functionality for interaction via webpages or similar web-enabled means, and database 523 such as to store and retrieve information relevant to administration functions or operations (such as, for example, a user's stored preferences or historical administration operations). In this manner it can be appreciated that a function of administration server 525 may be to provide functionality to other components that may operate specific means of interaction, while still optionally providing functionality directly to user applications or devices 510, thereby enabling a variety of arrangements and means of interaction according to the invention. It should be appreciated that, as described above with relation to a reporting server 524, an administration server 525 may operate independently of other components as appropriate, such as to provide administration functions to a user while utilizing external or third-party solutions for other functions described herein, such as report generation or web interaction. In this manner, an administration server 525 may operate in a SaaS or cloud-based manner according to the nature of a specific arrangement, and various alternate arrangements may be possible according to the invention.

Administration server 525 may contextualize or normalize metrics reported such as (for example) with per-capita, relative, or distribution measurements. Metrics in the art often are recorded as raw numerical data such as “minutes played” being reported in a single active electronic game session. When contextualized, this metric data may become, for example, “minutes played per day”, or additionally contextualized for a particular cohort. Metrics reported might include a variety of relevant or desirable summary, demographic, revenue, spending, virtual currency, engagement, retention, gameplay, or churn metrics. Such metrics may be reported over time, facilitating use according to a variety of potential administrative actions such as those described above. Contextualized metrics may then be provided to reporting server 524 for use in reporting operations, such as to provide a user with detailed contextualized information on cohorts (for example, “this player has played x minutes per day” or “players who spend y per hour of gameplay are less likely to churn”, or other such contextualized metric-based information).

Administration server 525 may utilize open-source or other existing frameworks or elements such as for ease of integration with existing components that may already be in use (thereby lowering initial cost to a potential client, both in terms of monetary investment as well as infrastructure concerns). Administration may comprise such features as multi-tenancy and security models (user accounts, administrative access control), or the ability to view various read-only information such as user data (such as names, contact information, non-editable history, or other such information that may be identifiable with users), pricing rules, policy definitions, cohort definitions, and optionally the ability to synchronize data (such as for backup, version control, or synchronicity between multiple copies of similar data), such as is common in the art with cloud-based synchronization or data storage solutions.

It should be appreciated by one having ordinary skill in the art that the specific nature of a reporting server 524 or administration server 525 may vary according to the invention, such as optionally incorporating or utilizing open-source or third-party elements as are common in the art. It should be further appreciated that the interconnected and accessible nature of components of the system 520 of the invention may be seen as “closing the loop” between reporting and administration, allowing users 510 to perform administration tasks from within a report or in parallel, as may be afforded by a unified application interface (as would be operated by an application server 522) and that as described, the nature and function of system 520 may be adaptable to a variety of hardware architectures such as including (but not limited to) mobile computing devices (such as tablet computing devices or smartphones) or traditional desktop or server computer workstations. It should be further appreciated that various components of system 520 need not be physically collocated—that is, the specific nature of their interconnections and means of communications may vary according to the invention, such as direct cable or wired connections as may be appropriate for components located in close physical proximity (such as servers or similar computer hardware operating within the same physical location) or via network-based connections as may be appropriate for components operating in separate physical locations, effecting a distributed architecture. It should be further appreciated that certain components as described above may operate in a standalone, SaaS, or cloud-based manner, and it is the functions provided by these components that is relevant to the invention as described and claimed herein, and various alternate or additional arrangements of components utilizing various alternative components in place of or in addition to those described may be possible according to the invention.

### DETAILED DESCRIPTION OF EXEMPLARY EMBODIMENTS

FIG. 6 is a method diagram illustrating an exemplary method 600 by which a user might interact with the system of the invention (as described above, referring to FIG. 5) such as to view a report and then take actions based upon information viewed, according to a preferred embodiment of the invention. As illustrated, the method described is from the perspective of a user interacting with the system of the invention for yield management, to illustrate the practical benefits offered as envisioned by the inventors.

In an initial step 601, a user may connect to a yield management system via any of a variety of means according to their intended purpose, such as via a web interface or web-enabled application for viewing reports on a mobile computing device such as a smartphone (or other network-connected device). Such interaction means may be provided interchangeably or simultaneously by various components of a yield management system as described above, such as a reporting server providing a reporting interface directly to a connected user, or a web server providing a web-based interface for users to access from their devices as needed, or other such arrangements.

In a next step 602, a user may request (such as by browsing through a menu and making a selection, or by submitting search query, or other such means of navigating information via a computing device) reporting information. Such information may be viewed “live”, or as it is being generated, such as when a user may wish to monitor current operations, or it may be retrieved as needed from a storage such as a database, to provide a user with prior or historical data for review. In a next step 603, the user may be presented with the reporting information, optionally including various interactive elements or means for taking actions form within the report, such as modifying rules or metrics that may be contained within or related to content of the report. In this manner, a user may be presented with options for both content consumption (reading the report) and actionable means relevant to the requested content, within a single unified interface and optionally without any explicit request or action (or even knowledge) on the part of the user—that is, actionable content may be presented automatically regardless of the user's request, such that a user may be proactively provided with options that may be useful to them (rather than leaving it to the user to decide what actions they may want to take, and then seeking out a tool or means for taking those actions).

In a next step 604, a user may take action based on the reported information, such as submitting messages to be sent to other individuals (for example, notifying a player that their account status in a game has been updated based on their reported behavior in the game), modifying rules (such as changing the way in-game currency is exchanged with real-world currency), or modifying metrics that are reported (such as changing the basic content of the report to be more relevant to the user's interests). In a next step 605, the actions are processed (such as by an administration server, as described above), and a user may then request or be automatically provided with updated reporting information in a final step 606, facilitating a closed-loop operation model beginning again at a report viewing step 603. In this manner, it can be appreciated that the invention serves to provide users with a single unified means to view and modify their yield management operations, and in doing so yield management utility is made more accessible to users of varying skill or technical knowledge.

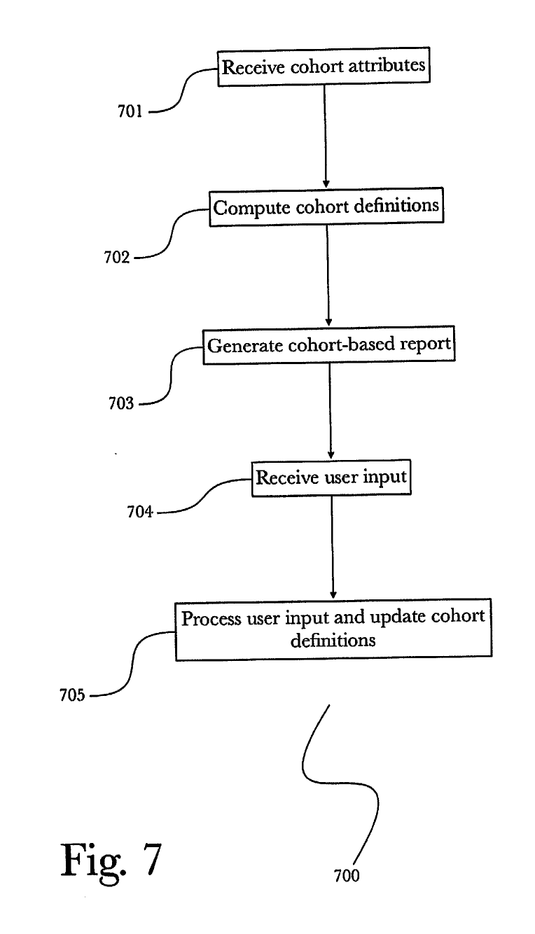

FIG. 7 is a method flow diagram, illustrating an exemplary method 700 for cohort-based yield management, according to a preferred embodiment of the invention (such as might utilize the system described above, referring to FIG. 5). In an initial step 701, a system for yield management may receive general cohort attribute information, such as from a preexisting database (such as when a yield management system is being connected to an existing arrangement, such as a gaming network or a business management system) or from connected cohorts (such as users interacting with a system, for example players in a game or customers in a CRM system). Cohort attributes might include, but are not limited to, usernames or identification information, account numbers, quantities of in-game currencies, character skills or other earned attributes, game items, or any other such information that may be considered relevant to a cohort in particular or to operation of a yield management system in general. In a next step 702, a cohorting server may generate cohort definitions, such as by associating various attribute information with specific cohorts (for example, associating a user's in-game items and currency with their username or account number), such that a cohort may now be considered to comprise a plurality of information both identifying the cohort as well as defining a variety of associates attributes or qualities. In a next step 703, a reporting server may utilize these generated cohort definitions to produce cohort-based reports, such as by calculating metric-based statistics or other quantifiable reporting output based at least in part on the cohort definitions. For example, based on a plurality of cohort definitions that include usernames as well as metrics describing each cohort's length of time participating in a game (for example), a report might indicate comparative playtimes for each cohort, optionally contextualized as described above (referring to FIG. 5) to provide more relevant information such as “hours per day” for each cohort. In this manner, it may be seen that by computing and utilizing cohort definitions, specific and relevant information relevant to yield management may be provided easily, and the use of cohort definitions and a cohorting server for computation may also make the contextualization of metrics easier to provide for enhanced yield management compared to solutions known in the art.

In a next step 704, a user (such as a yield management analyst) may view a generated report, such as to review the current state of cohorts or the operation of a system in general. A user may then submit input in a next step 705, such as by making selections on an interactive report display, or by interacting with a web-based or other such interactive application for yield management, for example to take action based on the reported information (for example, based on reported revenue-per-hour information, a user might choose to give select cohorts a “bonus” for their participation). In a final step 706, the user's input may then be processed such as by an administration server, applying any necessary changes and updating cohort information as appropriate such that user input may be immediately utilized in future cohort computation and reporting functions. In this manner, it may be appreciated that the method described herein offers a “closed-loop” means for a user to view and act upon yield management reports, enabling direct management when appropriate and incorporating any such actions in order to keep cohorts and reports up to date and relevant.

The skilled person will be aware of a range of possible modifications of the various embodiments described above. Accordingly, the present invention is defined by the claims and their equivalents.

What is claimed is:

1. A system for yield management, comprising:
a cohorting server stored and operating on a network-connected computing device;
a reporting server stored and operating on a network-connected computing device;
an administration server stored and operating on a network-connected computing device;
a web server stored and operating on a network-connected computing device;
an application server stored and operating on a network-connected computing device; and
a database stored and operating on a network-connected computing device;
wherein the cohorting server processes cohort definitions and makes the definitions available to the other components of the system;
wherein the reporting server generates reports based at least in part on the cohort definitions;
wherein the administration server processes actions based on user interaction;
wherein the web server operates a web-based interface for user interaction;
wherein the application server operates interactive software means for user interaction; and
wherein the database stores information from the other components of the system.

2. The system of claim 1, wherein the database stores the cohort definitions.

3. The system of claim 1, wherein the administration server modifies the cohort definitions.

4. The system of claim 3, wherein the reporting server generates reports based at least in part on the new cohort definitions.

5. A method for yield management, comprising the steps of:
receiving, at a cohorting server, cohort attribute information;
computing cohort definitions from the attribute information;
generating, using a reporting server, a cohort-based yield management report;
receiving, via an interactive user interface, user input from the yield management report; and
processing, using an administration server, the user input.

6. The method of claim 5, further comprising the step of updating the cohort definitions based at least in part on the user input.

7. The method of claim 5, wherein the interactive user interface is provided by a web server.

8. The method of claim 5, wherein the interactive user interface is provided by an application server.

9. The method of claim 5, wherein the interactive user interface is integral to the generated yield management report.
